(19) United States
(12) Patent Application Publication
(10) Pub. No.: US 2005/0257067 A1
(43) Pub. Date: Nov. 17, 2005

(54) Fingerprint embedding

(76) Inventor: David Keith Roberts, Crawley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/525,661

(22) PCT Filed: Jul. 21, 2003
(86) PCT No.: PCT/IB03/03290

§ 371 Date: Feb. 25, 2005

(30) Foreign Application Priority Data
Aug. 30, 2002 (EP) 02078567.1

(51) Int. Cl. H04K 1/00

(52) U.S. Cl. 713/186

(57) ABSTRACT

Disclosed is a method of embedding a fingerprint identifying media content into a media transmission signal used for transmission of said media content. In order to achieve that the embedded fingerprint survives all kinds of analogue and digital processing such as compression, the fingerprint (FP) extracted (21) from the content is converted (23) into the same signal format as used for the transmission of the content. For example, the fingerprint derived from a video signal generated by a security camera (1) is converted into image pixels. The fingerprint is subsequently accommodated (24) in a part of the signal being provided, but not being used, for transmission of content. For example, the fingerprint of video images is accommodated in the vertical blanking interval of a television signal. The converted fingerprint may also replace a small part of the original content.

### FIELD OF THE INVENTION

The invention relates to a method and an arrangement for embedding a fingerprint identifying media content into a media transmission signal used for transmission of said media content.

The invention also relates to a method and arrangement for retrieving a fingerprint from a media transmission signal used for transmission of said media content, and a method and arrangement for verifying the authenticity of media content.

### BACKGROUND OF THE INVENTION

A fingerprint, in the literature also often referred to as signature or hash, is a sequence of bits that is derived from multimedia content, e.g. an audio song, an image, a video clip, etc., and summarizes or identifies said media content.

Fingerprints are used, inter alia, in the field of authentication where it is desired to verify whether received content is original or to detect whether the content has been tampered with. To this end, a fingerprint being derived from the received content is compared with the original content's fingerprint. In this application, it is desired to transmit the original fingerprint along with the content that it was derived from.

International patent application WO 01/23981 summarizes a number of known methods of transmitting the fingerprint of a digital data work along with the content. The fingerprint can be transmitted as a separate file or embedded in the data file of the digital data work. In the latter case, the fingerprint can be accommodated in a header of the file, appended to the end of the file, or embedded in the content in the form of an embedded watermark. The fingerprint is preferably encrypted.

Embedding the fingerprint into the content by watermarking has the advantage of allowing transport of the fingerprint through existing processing chains. With careful design, a watermark can be sufficiently robust to allow correct extraction of the embedded fingerprint even after compression and analogue/digital conversion. However, the size of a fingerprint increases rapidly with improved accuracy of its representation of the content. An application such as authentication requires a relatively large fingerprint in order to provide good localization of tampered sections of the content. Robust watermarking schemes typically have a limited payload.

### OBJECT AND SUMMARY OF THE INVENTION

It is an object of the invention to provide an improved method of embedding a fingerprint identifying media content into a media transmission signal used for transmission of said media content.

To this end, the method in accordance with the invention comprises the steps of converting said fingerprint into a format that the media transmission signal provides for transmission of said media content, and accommodating the converted fingerprint in a predetermined part of the media transmission signal not being used for transmission of said media content.

It is achieved with the invention that the fingerprint can be accommodated in existing standard media transmission formats without requiring any modification of said signal formats or increasing the length of the signal. The method has the same advantage as the prior art method of watermark embedding (allowing transport of the fingerprint through existing processing chains), but does not suffer from payload limitations.

Some transmission formats have spare capacity for the accommodation of media content. For example, television signals have a vertical blanking interval in which content can be transmitted, but such content will not be displayed by standard television receivers. In an embodiment of the method in accordance with the invention, the fingerprint of a video image or a series of video images is accommodated in lines of said vertical blanking interval, possibly in a manner which is compatible with the well-known teletext data transmission.

If the transmission format does not provide such spare capacity, a small part of the media content can be sacrificed to create space for the fingerprint. For example, a few lines at the upper and/or lower border of a video image can be used to accommodate the converted fingerprint of (the rest of) the video image. Said few lines are normally not visible on the screen of a standard television receiver. To this end, an embodiment of the method in accordance with the invention comprises the steps of dividing the media content into a first part and a second part, deriving the fingerprint from the first part of said media content, and replacing the second part of said media content by the converted fingerprint.

### BRIEF DESCRIPTION OF THE DRAWINGS

These and other aspects of the invention are apparent from and will be elucidated with reference to the embodiments shown in the drawing, in which:

FIG. 1 shows schematically a video surveillance system including an arrangement for embedding fingerprints in accordance with the invention.

FIG. 2 shows a flow chart of operations carried out by a conversion circuit which is shown in FIG. 1.

FIGS. 3 and 4 show diagrams to illustrate the operation of an embodiment of the method in accordance with the invention.

FIG. 5 shows a flow chart of operations carried out by an arrangement for verifying the authenticity of media content in accordance with the invention.

### DESCRIPTION OF EMBODIMENTS

The invention will be described with reference to a video surveillance system.

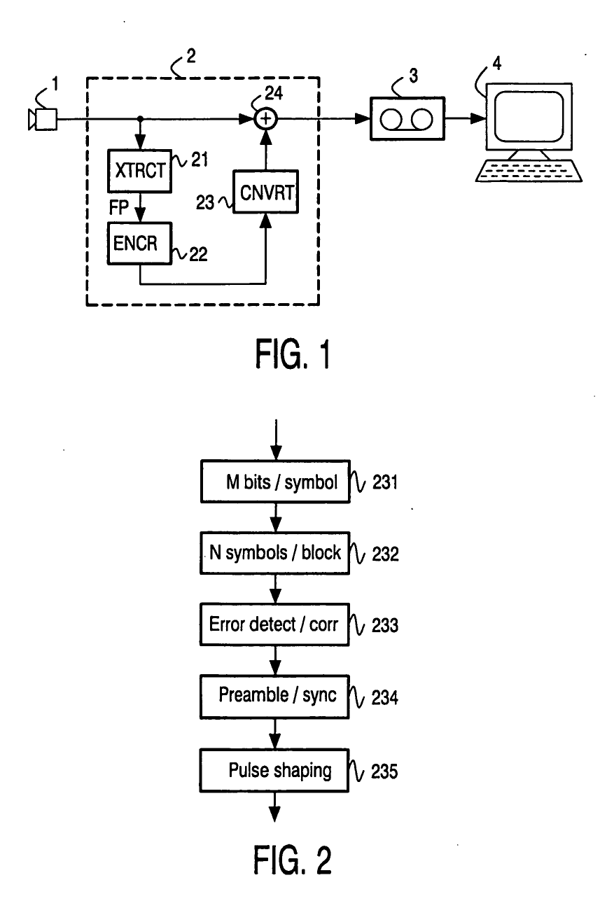

FIG. 1 shows schematically a typical layout of such a system. It comprises one or more surveillance cameras 1, each of which supplies a video signal in a standard analogue (PAL, NTSC) signal format. Each video signal is applied to a fingerprint extraction and embedding unit 2. A digital recorder 3 records the signals in compressed form. A computer 4 provides access to the stored video signals for retrieval, viewing and authentication. The ability to authenticate images captured by the cameras will increase the value of these images as evidence in a court of law.

The fingerprint extraction and embedding unit 2 comprises an extraction circuit 21 for deriving a fingerprint FP from each video image and embedding it into the camera signal. The unit 2 is preferably located inside the camera 1 to prevent tampering with the image content before fingerprint calculation. The fingerprint FP is a sequence of bits that summarizes the image content. It is generated in such a way that a tampered version of the same image gives a substantially different fingerprint, but an image processed by allowable manipulations, such as compression, does not. Many methods of deriving fingerprints from audio and video material are known in the art. A practical embodiment of the extraction circuit 21 that can be used in the system is described in Job Oostveen, Ton Kalker and Jaap Haitsma, “Visual Hashing of Digital Video: Applications and Techniques”, SPIE, Applications of Digital Image Processing XXIV, Jul. 31-Aug. 3, 2001, San Diego, USA. The extracted fingerprint FP is encrypted by an encryption circuit 22. The encrypted fingerprint is converted, by a converter stage 23, into the same format as used for the transmission of the video image. In this example, the converter stage 23 converts the fingerprint into image pixels and accommodates said pixels into one or more conventional analogue television lines. The fingerprint is subsequently inserted in the television signal by an insertion circuit 24. In FIG. 1, the insertion circuit 24 is symbolically shown as an adder.

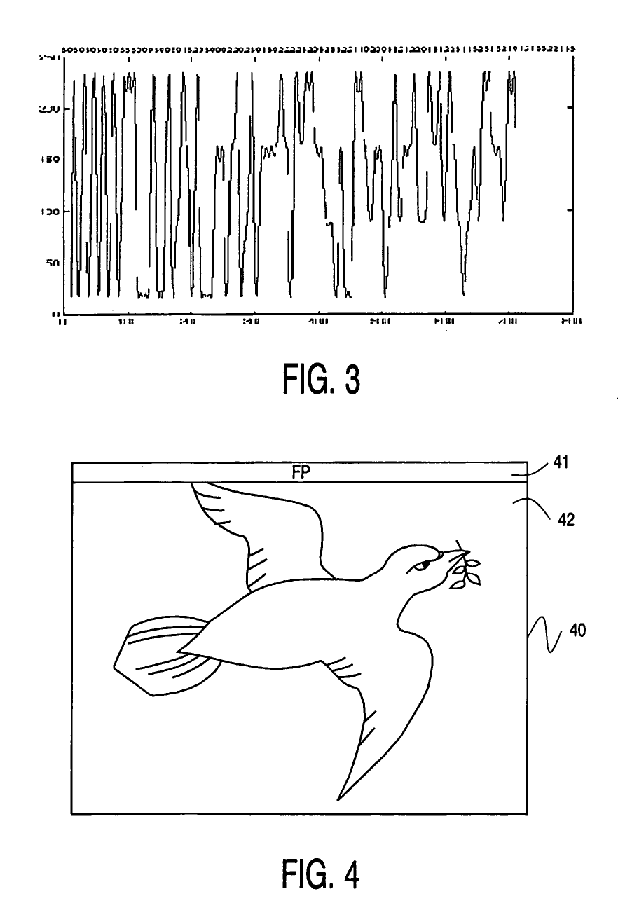

FIG. 2 shows a flow chart of steps carried out by the converter stage 23. In a step 231, the fingerprint bits are grouped into symbols of M bits per symbol. In a step 232, the symbols are grouped into blocks of up to N symbols. In an optional step 233, additional error detection and correction symbols are appended to each block. In a step 234, a preamble and a synchronization word are placed at the start of each block of symbols. A preamble may be required at the receiver end in order to help the receiver to derive a clock signal identifying the timing of the symbol edges. It is typically a pattern of alternating symbols with the largest difference between them, e.g. 101010 for M=1 or 707070 for M=3. The synchronization word is a pattern of symbols with good autocorrelation properties, used to mark the end of the preamble and the beginning of fingerprint data. Additionally, the synchronization word prevents problems caused by line jitter introduced by transmission via an analogue link, as it identifies the start of the data, even if the data has moved relative to the beginning of a video line. In a step 235, pulse shaping is applied that maps each sequence of symbols into a continuous signal whose amplitude fits within the range of the video signal. A typical choice of pulse shape is a ‘raised-cosine’ pulse. Pulse shaping smoothes out the transitions between data symbols, reduces the bandwidth of the signal, and helps reduce inter-symbol interference when the signal is transmitted via a band-limited channel.

The choice of parameters M and N is dependent upon the processing operations that the embedded fingerprint must survive. The number N of symbols per television line is chosen to be such that the signal bandwidth is sufficiently narrow. The number M of bits per symbol provides control over the trade between data rate and bit error rate.

FIG. 3 shows a typical waveform of a fingerprint signal supplied by the converter stage 23. In this example, four signal values can be discerned for the symbol values 0, 1, 2 and 3 (M=2) corresponding to fingerprint bit pairs 00, 01, 10 and 11. A preamble 3030303030 and a synchronization word 33300030030 precede the actual fingerprint data.

The fingerprint signal is finally inserted, by the insertion circuit 24, in lines of the television signal that are suitable for but not used for the transmission of image data. In the case of a conventional PAL or NTSC television signal, the fingerprint signal can be accommodated in lines of the vertical blanking interval in a manner known from teletext. For M=1 and N=320, the fingerprint signal is even identical to a PAL teletext data signal. This has the advantage that the fingerprint can easily be retrieved by conventional teletext circuitry.

In some circumstances, embedding the fingerprint in lines of the vertical blanking interval may not be appropriate. For example, during MPEG compression, these lines will be stripped off. In these cases, the fingerprint data is embedded into the visible portion of the video and replaces the actual image content. In practice, the size of the fingerprint is sufficiently small, so that the data will occupy only a small portion of the image, for example, 4 of 288 lines of a PAL field. An example thereof is shown in FIG. 4, where reference numeral 40 denotes the original video image area. In this embodiment, a small region 41 of the original image area is used to accommodate the fingerprint FP being extracted from the image covered by the remainder 42 of the original image area. The region 41 will usually fall outside the visible area of the screen of a conventional television receiver. If the region 41 is visible, the fingerprint will become manifest as black, gray and white pixels, popularly referred to as ‘snow’. The visibility of the embedded fingerprint may be advantageous. It gives the user the visual assurance that the content is protected against tampering.

In many applications, the embedded fingerprint data may be required to survive lossy compression. This requires a bandwidth restriction of the embedded fingerprint signal, not only in the horizontal direction (by appropriate selection of the parameters M and N as well as design of the raised cosine filter), but also in the vertical direction. Possible techniques to ensure that the embedded lines of data present low frequencies in the vertical direction are (i) duplicating lines of embedded fingerprint data, and (ii) inserting lines that provide smooth transitions between consecutive lines.

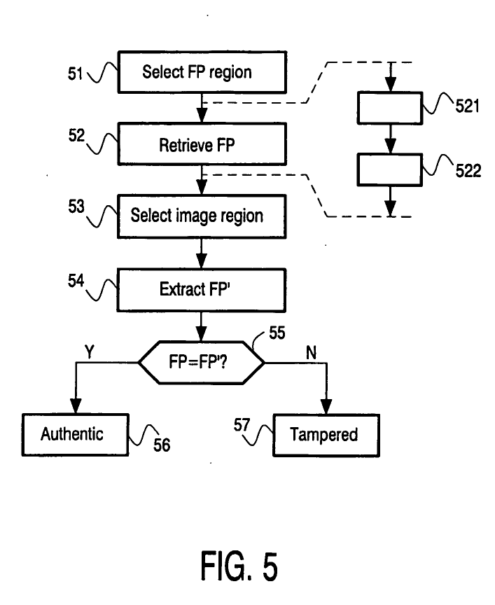

FIG. 5 shows a flow chart of steps carried out by the computer 4 (see FIG. 1) to verify the authenticity of a received image. In a step 51, the part of the television signal into which the fingerprint has been embedded (i.e. the vertical blanking interval or image area 41 in FIG. 4) is selected. In a step 52, the embedded fingerprint FP is retrieved. With reference to the embedding embodiment described above, this step 52 includes a step 521 in which the appended preamble and sync word are used to determine the positions along a television line where the “pixels” representing fingerprint symbols are located, and a step 522 in which the pixel values are converted into respective symbol values (0, 1, 2 or 3 for M=2 as in FIG. 3) by means of slicing (comparing the pixel values with respective thresholds). In a step 53, the image region is selected (e.g. image area 42 in FIG. 4). In a step 54, a fingerprint FP′ is derived from this region in a manner described above. The embedded fingerprint FP and the fingerprint FP′ derived from the received image are subsequently compared in a step 55. If they substantially match, the received image is declared authentic (step 56). Otherwise, it is concluded that the image has been tampered with (step 57).

Disclosed is a method of embedding a fingerprint identifying media content into a media transmission signal used for transmission of said media content. In order to achieve that the embedded fingerprint survives all kinds of analogue and digital processing such as compression, the fingerprint (FP) extracted (21) from the content is converted (23) into the same signal format as used for the transmission of the content. For example, the fingerprint derived from a video signal generated by a security camera (1) is converted into image pixels. The fingerprint is subsequently accommodated (24) in a part of the signal being provided, but not being used, for transmission of content. For example, the fingerprint of video images is accommodated in the vertical blanking interval of a television signal. The converted fingerprint may also replace a small part of the original content.

1. A method of embedding a fingerprint (FP) identifying media content into a media transmission signal used for transmission of said media content, the method comprising the steps of:
converting (23) said fingerprint into a format that the media transmission signal provides for transmission of said media content, and
accommodating (24) the converted fingerprint in a predetermined part of the media transmission signal not being used for transmission of said media content.

2. A method as claimed in claim 1, further comprising the steps of:
dividing said media content (40) into a first part (42) and a second part (41),
deriving said fingerprint (FP) from the first part (42) of said media content, and
replacing the second part (41) of said media content (40) by said converted fingerprint.

3. A method as claimed in claim 1, further comprising the step of encrypting (22) the fingerprint.

4. A method as claimed in claim 1, in which the media content is a video image or a sequence of video images and the media transmission signal is a television signal, wherein the converted fingerprint is accommodated in lines of the vertical blanking interval.

5. A method as claimed in claim 4, wherein the converted fingerprint is a teletext data signal.

6. A method as claimed in claim 2, in which the media content is a video image or a sequence of video images and the media transmission signal is a television signal, wherein the fingerprint is converted into a video signal and accommodated in overscan lines (41) of the television signal that constitute a border of an area being displayed on the screen of a television receiver.

7. A method of retrieving a fingerprint identifying media content from a media transmission signal used for transmission of said media content, characterized in that the method comprises the step of converting a predetermined part of the media transmission signal not being used for transmission of said media content from a format being used for transmission of said media content into a format representing said first fingerprint.

8. A method as claimed in claim 7, further comprising the steps of:
dividing said media content into a first part and a second part,
retrieving said fingerprint from the first part of said media content.

9. A method as claimed in claim 7, further comprising the step of decrypting the first fingerprint.

10. A method as claimed in claim 7, in which the media content is a video image or a sequence of video images and the media transmission signal is a television signal, wherein said step of converting comprises decoding a teletext signal accommodated in lines of the television signal that are not used for transmission of said video image or video images into said first fingerprint.

11. A method as claimed in claim 8, in which the media content is a video image or a sequence of video images and the media transmission signal is a television signal, wherein said step of converting comprises converting overscan lines of the television signal that constitute a border of an area being displayed on the screen of a television receiver into said first fingerprint.

12. A method of verifying the authenticity of media content, comprising the steps of:
receiving a media transmission signal representing said media content and a first fingerprint identifying said media content,
deriving a second fingerprint from the received media content,
determining that the media content is authentic if the first and second fingerprints resemble each other in a predetermined manner,
characterized in that the step of receiving the first fingerprint comprises converting a predetermined part of the media transmission signal not being used for transmission of said media content from a format being used for transmission of said media content into a format representing said first fingerprint.

13. An arrangement (2) for embedding a fingerprint (FP) identifying media content into a media transmission signal used for transmission of said media content, the arrangement comprising:
conversion means (23) for converting said fingerprint into a format that the media transmission signal provides for transmission of said media content, and
means (24) for accommodating the converted fingerprint in a predetermined part of the media transmission signal not being used for transmission of said media content.

14. An arrangement for retrieving a fingerprint (FP) identifying media content from a media transmission signal used for transmission of said media content, characterized in that the arrangement comprises means (522) for converting a predetermined part of the media transmission signal not being used for transmission of said media content from a format being used for transmission of said media content into a format representing said first fingerprint.

15. A computer program to be run on a computer (4), and causing said computer to carry out a method of verifying the authenticity of media content as claimed in claim 12.

16. A media transmission signal comprising media content in a predetermined transmission format, characterized in that a part of said media content in the predetermined transmission format represents a fingerprint derived from and identifying the remaining part of said media content.
